(19) United States
(12) Patent Application Publication
(10) Pub. No.: US 2013/0019271 A1
(43) Pub. Date: Jan. 17, 2013

(54) MULTIMEDIA BROADCASTING MANAGEMENT SYSTEM AND METHOD IN PUBLIC SANITARY SPACE

(71) Applicants: Yuan-Ye Chiu, New Taipei City (TW); Ching-Hsien Ying, New Taipei City (TW); Heng-Yen Liu, New Taipei City (TW)

(72) Inventors: Yuan-Ye Chiu, New Taipei City (TW); Ching-Hsien Ying, New Taipei City (TW); Heng-Yen Liu, New Taipei City (TW)

(73) Assignee: Alliance Service International Corporation

(21) Appl. No.: 13/453,119

(22) Filed: Apr. 23, 2012

(30) Foreign Application Priority Data
Jul. 13, 2011 (TW) 100124837

(51) Int. Cl. H04N 21/633; E03D 5/10

(52) U.S. Cl. 725/80

(57) ABSTRACT

A multimedia broadcasting management system and method in a public sanitary space are provided. A flush control device installed on a sanitation apparatus in the public sanitary space is adapted to broadcast multimedia data through a broadcast module thereof. The flush control device is connected to a transmission network to receive the multimedia data through therethrough. After sensing a user enters a sensing range, the flush control device not only outputs a flush control signal to flush the sanitation apparatus, but also controls to broadcast the multimedia data.

### CROSS-REFERENCES TO RELATED APPLICATIONS

This non-provisional application claims priority under 35 U.S.C. §119(a), on Patent Application No. 100124837 filed in Taiwan, R.O.C. on Jul. 13, 2011, the entire contents of which are hereby incorporated by reference.

### BACKGROUND OF THE INVENTION

1. Technical Field

The disclosure relates to a multimedia broadcasting management technology, and more particularly, to a multimedia broadcasting management system and method that is applied to sanitation apparatuses installed in one or more public sanitary space and integrated with a flush control device respectively.

2. Related Art

Advertisement broadcasting in public areas nowadays is very common in shopping malls and commercial buildings. On the walls of food courts, shop-windows, inside or outside of elevators, advertisements are widely broadcasted on display devices. Such display device may be defined as a type of digital signage according to its usage of broadcasting advertisements.

The commercial effects of broadcasting the advertisements through digital signage may be measured by the amount of the viewers and the viewing time. However, it is difficult to gather precise statistics of the actual number of viewers or the individual viewing time in the prior art. For example, when a pedestrian stops at a position within a certain distance from a certain digital signage, instead of watching the advertisements, he or she may be possibly looking at nearby goods or having a conversation with others. However, generally such pedestrian is still recorded and counted as a viewer of the advertisement.

In the conventional art, a digital signage may be additionally equipped with a camera, so as to identify the possible viewers among many pedestrians within a certain distance, and obtain relatively credible data of viewer numbers for further estimating the advertising effect.

Nevertheless, under the world's urgent demand of saving energy today, a great deal of there are still some digital signages broadcasting advertisements without any viewers, which keeps broadcasting no matter the passersby stay or not, not only causes severe energy waste and fails to achieve the desirable advertising effect.

### SUMMARY

In view of problems in the conventional art, an embodiment of the disclosure provides a multimedia broadcasting management system in a public sanitary space, so as to broadcast multimedia data and output a flush control signal. The system includes one or more flush control devices, installed in one or more public sanitary spaces. The flush control device includes a network module, a sensing module, a processing module and a broadcasting module. The network module is connected to a transmission network; the sensing module senses if a user is in a sensing range and generates a sensing signal accordingly. The broadcasting module includes a broadcast unit. The processing module is connected electrically to the network module, the sensing module and the broadcasting module; the processing module receives the sensing signal from the sensing module, and receives multimedia data transmitted through a transmission network. When sensing the user stays in the sensing range for a sensed in-use duration, the processing module outputs a flush control signal within the sensed in-use duration, and the broadcasting module broadcasts the multimedia data within the sensed in-use duration.

Another embodiment of the disclosure provides a multimedia broadcasting management system in a public sanitary space. The system includes a transmission network, multiple flush control devices and one or more local servers. The flush control devices are installed in one or more public sanitary spaces. Each flush control device includes a network module, a sensing module, a processing module and a broadcasting module. The network module is connected to the transmission network. The sensing module senses a user in front of a sanitation apparatus and generates a sensing signal according. The broadcasting module includes a broadcast unit. The processing module is connected electrically to the network module, the sensing module and the broadcasting module; the processing unit receives the sensing signal, and outputs sensing data through the network module. The local server is connected to the flush control devices through the transmission network, so as to receive the sensing data, and transmit the multimedia data to the flush control device through the transmission network. After sensing a user has entered the sensing range, the processing module outputs the flush control signal, and controls the broadcasting module to start to broadcast the multimedia data.

Another embodiment of the disclosure provides a multimedia broadcasting management method in a public sanitary space, which is applied to a flush control device corresponding to a sanitation apparatus in a public sanitary space. The method includes: connecting the flush control device to a transmission network; receiving multimedia data through the transmission network; sensing if a user stays within a sensing range for a sensed in-use duration; and outputting a flush control signal within the sensed in-use duration, and broadcasting the multimedia data within the sensed in-use duration.

### BRIEF DESCRIPTION OF THE DRAWINGS

The disclosure will become more fully understood from the detailed description given herein below for illustration only, and thus not limitative of the disclosure, wherein:

FIG. 1 is a system block diagram of a multimedia broadcasting management system in a public sanitary space according to an embodiment of the disclosure;

FIG. 2A is an example view #1 of a broadcasting and flush mechanism for a multimedia broadcasting management system in a public sanitary space according to another embodiment of the disclosure;

FIG. 2B is an example view #2 of a broadcasting and flush mechanism of a multimedia broadcasting management system in a public sanitary space according to another embodiment of the disclosure;

FIG. 3 is a flow chart of a multimedia broadcasting management system in a public sanitary space according to another embodiment of the disclosure;

FIG. 4 is a configuration diagram of a public sanitary space of a multimedia data broadcasting system according to another embodiment of the disclosure; and

FIG. 5 is an operational state diagram of a multimedia broadcasting management system in a public sanitary space according to another embodiment of the disclosure.

### DETAILED DESCRIPTION

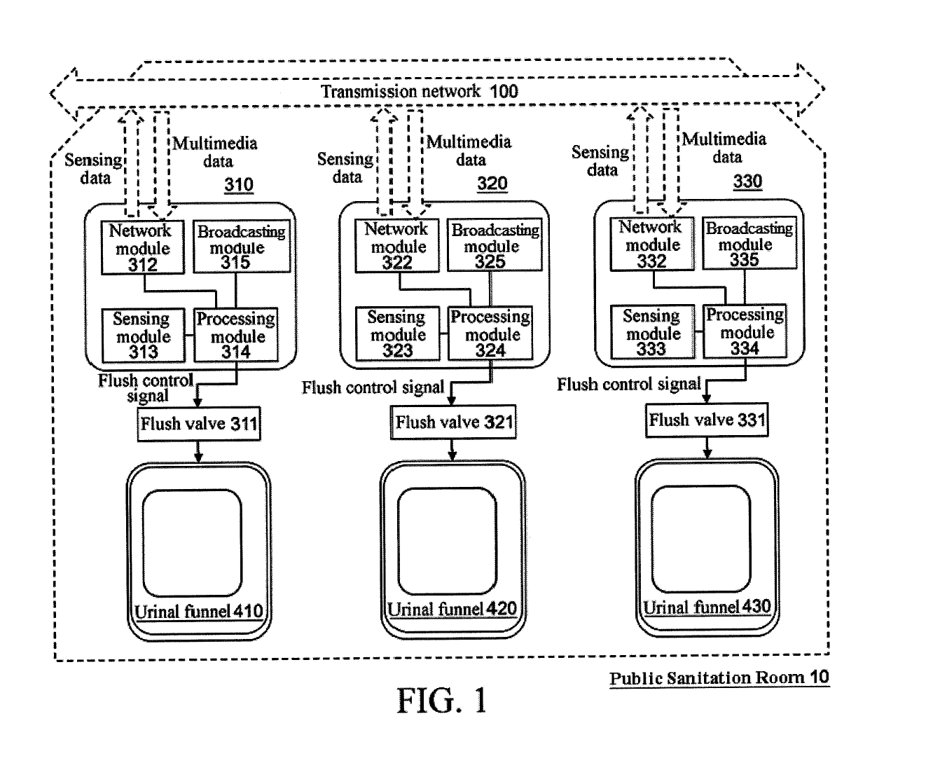

FIG. 1 is a system block diagram of a multimedia broadcasting management system in a public sanitary space according to an embodiment of the disclosure. The public sanitary space in the disclosure includes public places with public sanitation apparatus (e.g. toilets); the public places include private buildings, business office buildings, theaters, train/bus stations, airports, hospitals, shopping malls or supermarkets, or any other buildings or locations. The public toilets in places like shopping malls may be used by unspecific people, while public toilet in the private building or the business office building may be used only by limited people lived or working in the building.

As shown in FIG. 1, the multimedia broadcasting management system in the public sanitary space is mainly installed in the public sanitary space 10, and includes one or more flush control devices (310, 320 and 330 in the drawing). The flush control devices 310, 320 and 330 are respectively connected to a flush valve 311/321/331 corresponding to urinal funnels 410, 420, and 430 (namely, sanitation apparatus), in the public sanitary space 10. The flush valve 311/321/331 is respectively connected to an external water source (not shown), and the corresponding urinal funnel 410/420/430, is a water control valve (for example, a solenoid valve), the opening or closing of which is controlled by a flush control signal to further control the flush duration each time and the flush frequency for the urinal funnel 410/420/430.

Each flush control device 310/320/330 has a network module 312/322/332, a sensing module 313/323/333, a processing module 314/324/334, and a broadcasting module 315/325/335 respectively.

The network module 312/322/332 is electrically connected to a transmission network 100. The transmission network 100 may be a private network or a public network formed in wired or wireless architecture, a part of the private network or the public network may be selectively connected through Internet. The network module 312/322/332 may be a wired network transmission module, such as a phone line, a Cable TV, Ethernet, a Video Graphics Array (VGA), transmission line, a Audio/Video (AV), signal transmission line, Power Line Communication (PLC), a coaxial cable network, an optical network, Ethernet, or a telecommunication network module such as a Digital Subscriber Line (DSL)/an Integrated Services Digital Network (ISDN)/an Asymmetric Digital Subscriber Loop for the connection and transmission. The network module 312/322/332 may also be a wireless network transmission module, such as a Wireless Local Area Network (LAN), (any version conforming to the IEEE802.11 standard), Wireless AV transmission, Bluetooth transmission, Ultra-Wide Band (UWB), transmission, Zigbee wireless transmission, Wireless Fidelity (Wi-Fi), Direct wireless transmission, Worldwide Interoperability for Microwave Access (WiMAX), mobile phone transmission (for example, GSM, CDMA, WCDMA, CDMA2000, TDS-CDMA . . . ), digital television transmission (for example, DVB-Cable, Satellite, Terrestrial), analog television signal transmission (Ultrahigh Frequency (UHF), Very High Frequency (VHF)), and broadcasting signal transmission (frequency modulation (FM), amplitude modulation (AM)), for the connection and transmission.

The sensing module 313/323/333 may be realized by an infrared sensor, an ultrasound sensor, an optical sensor, a thermal sensor, or an image sensor which is adapted to detect if a user enters or leaves a sensing range and generate a sensing signal accordingly. Generally, the sensing range of the sensing module 313/323/333 is within a certain distance in front of the urinal funnel 410/420/430. No matter whether or not the user enters or leaves the sensing range, the sensing module 313/323/333 can generate the sensing signal. In an embodiment, the sensing signal may be an information packet formed by data such as a device identification code, an in/out indication code, the in/out duration, the flush duration and the overall amount. Since the sensing signal represents the user's entry or exit of the sensing range, the processing module 314/324/334 in an embodiment may control the flush valve 311/321/331 to perform fore-flush/post-flush according to the sensing signal, or may start or stop the multimedia broadcasting according to the sensing signal.

The broadcasting module 315/325/335 at least includes a broadcast unit (not shown), such as a liquid crystal broadcast (LCD), an organic electroluminescent display or other panel displays, and in another embodiment, the broadcast module may be a micro projector. A sound amplification unit (not shown), may be additionally set to achieve a desirable multimedia broadcasting effect. At least a sound amplification unit needs to be installed at the public sanitary space.

The processing module 314/324/334 is electrically connected to the flush valve 311/321/331, the network module 312/322/332 and the sensing module 313/323/333 respectively. The processing module 314/324/334 may respectively include several flush modes, and output a flush control signal after receiving the sensing signal, so as to control the opening or closing of the flush valve 311/321/331, and further control the amount of water consumed by flushing the urinal funnel 410/420/430. The processing module 314/324/334, for example including a computing unit and a memory unit (both not shown), receives the sensing signal and determines the use status of the sanitation apparatus. The fore-flush duration of the flush valve 311/321/331, the post-flush duration and the amount of consumed water during the flushing process thereof, together with the data such as the amount of users, the in-use duration, and even identification codes and positional codes of the building, the public sanitary space thereof and the sanitation apparatus that may be calculated according to the sensing signal, may all be recorded as “sensing data” by the processing module 314/324/334. On the contrary, for the purpose of simplifying the flush control devices, in an embodiment, the transmitted sensing data may merely include the data such as the device identification code, the in/out indication code (enter or leave the sensing range), and the in/out duration. The sensing data may be output from the processing module 314/324/334 to the transmission network 100 through the network module 312/322/332. Each flush control device 310/320/330 of the multimedia broadcasting management system in the public sanitary space may be controlled remotely and set through the transmission network 100.

Generally, during the use process, after the sensing module 313/323/333 detects the user for a certain period of time, the processing module 314/324/334 opens the flush valve 311/321/331 to release a certain amount of water and flush the urinal funnel 410/420/430 for a very first time, which is defined as “fore-flush”; the flush duration thereof is defined as “fore-flush duration”. When the sensing module 313/323/333 detects that the user leaves, (namely, the user has finished urinating), the processing module 314/324/334 controls the flush valve 311/321/331 to re-open, so as to release a certain amount of water to flush the urinal funnel 410/420/430 for a second time, which is defined as “post-flush”; the flush duration thereof is defined as “post-flush duration”. The description in this paragraph is related to the basic modes of flush control by the processing module 314/324/334 when a single user uses the sanitation apparatus.

In addition, the multimedia data may be transmitted to the processing module 314/324/334 through the transmission network 100 and the network module 312/322/332 of the flush control device 310/320/330, and may be selectively and temporarily stored in a memory unit (not shown) of the processing module 314/324/334. The multimedia data is selected from the group consisting of machine readable/playbackable image files, video files, audio files, music files, and animation files, or any combination thereof.

In the embodiment of the disclosure, since the processing module of the flush control device is directly used to control the multimedia broadcasting of the broadcasting module, a direct relation exists between the sensing flush mechanism and the multimedia broadcasting mechanism during the use process of the sanitation apparatus.

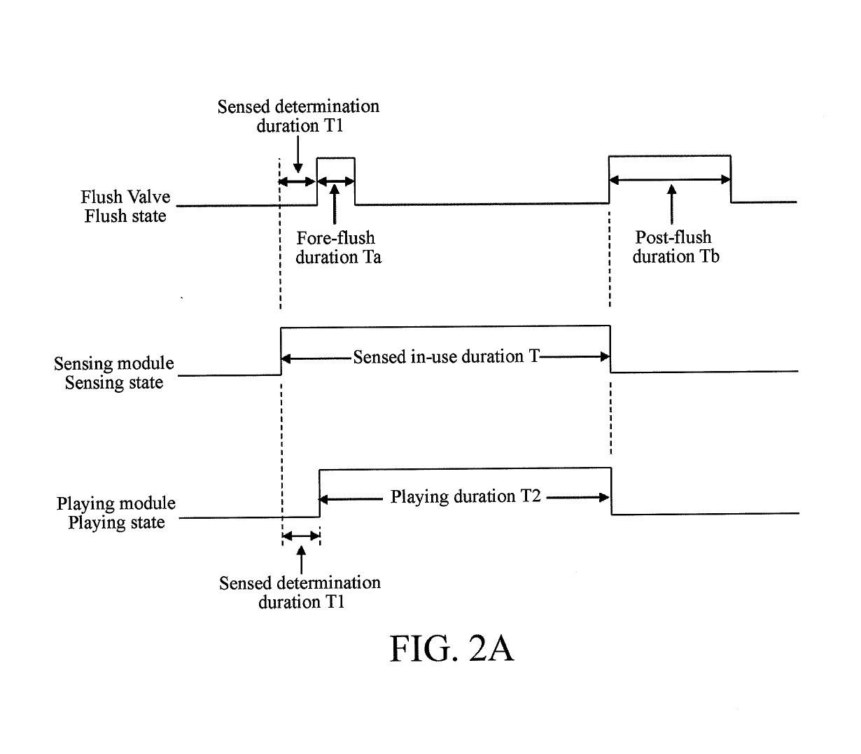

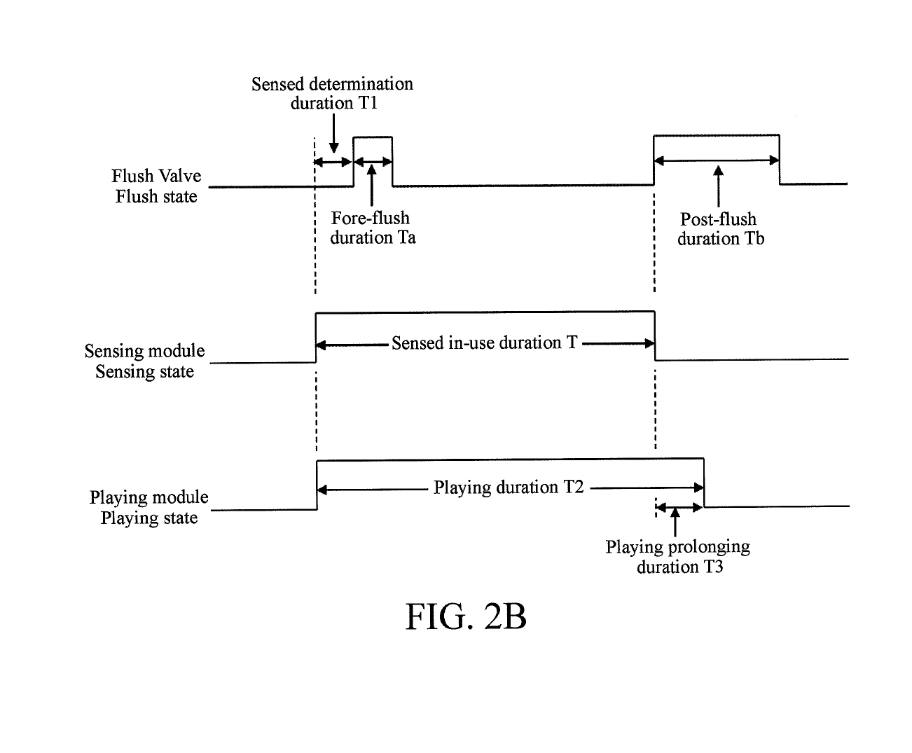

FIG. 2A is an example view #1 of a broadcasting and flush mechanism of a multimedia broadcasting management system in a public sanitary space according to an embodiment of the disclosure. Please refer to FIG. 2A, in which a sensing module 313/323/333 senses that a user enters and stays within the sensing range in front of a sanitation apparatus (namely, a urinal funnel 410/420/430); and the entire period of time staying in the sensing range is defined as “sensed in-use duration” T. Started from the time point that the sensing module 313/323/333 senses the user, as long as the sensing module 313/323/333 senses the user for a certain duration, the system determines that the user is actually using the sanitation apparatus instead of just passing by; such a determining period of time is defined as “sensed determination duration” T1, which is at the front part of the sensed in-use duration T. The sensed determination duration T1 may be set at two seconds, or selectively adjusted to any other durations.

When the sensing module 313/323/333 continuously senses the user for the sensed determination duration T1, the processing module 314/324/334 starts to broadcast multimedia data through the broadcasting module 315/325/335 and outputs a flush control signal at the same time to open a flush valve 311/321/331. One or more segments of the multimedia data may be broadcasted during the duration, depending on how long the sensed in-use duration T is. As to the flush mechanism, when the flush valve 311/321/331 is opened to perform the fore-flush for the fore-flush duration Ta, the processing module 314/324/334 closes the flush valve 311/321/331.

If the sensing module 313/323/333 senses that the user leaves the sensing range, namely, the sensed in-use duration T is over, it is no longer necessary to broadcast the multimedia data continuously if no subsequent user arrives. At this moment, the broadcasting module 315/325/335 may stop broadcasting the multimedia data. Practical implementation examples to stop broadcasting the multimedia are provided as follows: (1) turning off a main power source and a backlight component power source of the broadcasting module 315/325/335; (2) broadcasting a screen protection program on the broadcasting module 315/325/335; (3) disable the broadcasting module 315/325/335 to enter a standby mode or a sleep mode. As to the flush mechanism, once the user leaves, namely, the sensed in-use duration T is over, the flush valve 311/321/331 is opened again to perform flushing for the post-flush duration Tb.

In an embodiment, the broadcasting modules 315/325/335 of multiple flush control devices 310/320/330 installed in the same public sanitary space may synchronously broadcast the same multimedia data. Certainly, in another embodiment, when different users start to use the urinal funnel 410/420/430 at different time points, the flush control devices 310, 320, and 330 may have different sensed in-use durations T, sensed determination durations T1, broadcasting durations T2, fore-flush durations Ta and post-flush durations Tb; these durations have different starting and stopping time points. Even if different users respectively start to use the urinal funnel 410/420/430 at the same starting time point, the foregoing durations may still not start or end at the same time.

In an embodiment, the sensed in-use duration T may be a sum of the sensed determination duration T1 and the broadcasting duration T2. Actually, when the user is sensed during the sensed determination duration, the multimedia data is broadcasted, while when sensing the user leaves, the multimedia data are stopped broadcasting and the urinal funnel is flushed for the post-flush duration.

In addition, during the continuous use of the sanitation apparatus/urinal funnel, the fore-flush duration Ta may be prolonged, and the post-flush duration Tb may be shortened or canceled until the last user finishes; and then longer post-flush duration Tb is performed, so that the sanitation apparatus is maintained at a certain clean status.

In the embodiment as shown in FIG. 2A, starting and stopping time points of the broadcasting of the multimedia data are synchronous with time points of the fore-flush and the post-flush of the flush valve, namely, the broadcasting duration T3 of the multimedia data is equal to the sensed in-use duration T. In an embodiment, the broadcasting duration T2 of shorter multimedia data may be smaller than the sensed in-use duration T. However, in another embodiment, in order to increase the broadcasting effect, a broadcasting prolonging duration T3 (for example, multiple segments of multimedia data may be broadcasted), may be prolonged, so that the broadcasting duration T2 is greater than the sensed in-use duration T.

FIG. 2B is an example view #2 of a broadcasting and flush mechanism of a multimedia broadcasting management system in a public sanitary space according to an embodiment of the disclosure. Please refer to FIG. 2B, after detecting a user has entered the sensing range of the sending module 313/323/333, the processing module 314/324/334 may control the broadcasting module 315/325/335 to directly perform broadcasting, without pending for the sensed determination duration T1. When the user leaves, namely, the sensed in-use duration T is over, the flush valve 311/321/331 is opened again to perform flush to the post-flush duration Tb. When the user leaves, namely, the sensed in-use duration T is over, the flush valve 311/321/331 is opened again to perform flush to the post-flush duration Tb. However, in order to increase the broadcasting effect, the broadcasting module 315/325/335 may prolong the broadcasting to the broadcasting prolonging duration T3. During the broadcasting prolonging duration T3, the original user may temporarily stop and continuously view the content, and the next user may also continue to view the content from the time of starting to use the sanitation apparatus to the time of finishing such use.

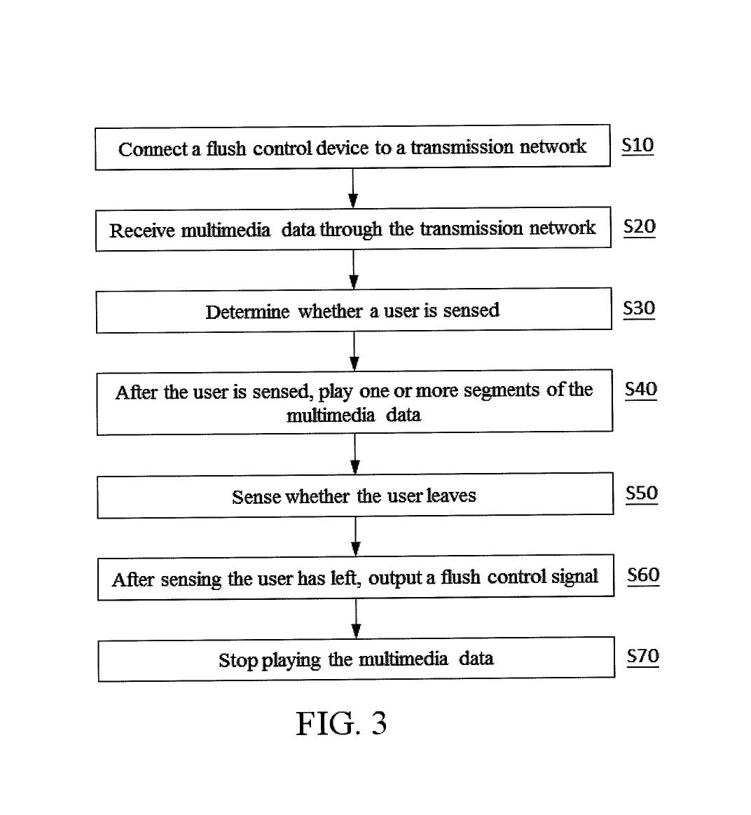

FIG. 3 is a flow chart of a multimedia broadcasting management method in a public sanitary space according to an embodiment of the disclosure. Please refer to FIG. 3, in which the multimedia broadcasting management method in the public sanitary space provided by this embodiment is applied to a flush control device installed on one or more sanitation apparatuses in one or more public sanitary spaces, and includes the following steps.

Step S10: Connect a flush control device to a transmission network. Thus, the flush control device is controllable through the transmission network; also multimedia data are able to be received through the transmission network (Step S20); and sensing data are transmittable outwardly through the transmission network (another possible step). As to the conventional sanitation apparatus in the public sanitary space, it is already difficult to connect the flush control device on the sanitation apparatus to a private network.

Step S30: Determine whether a user is sensed (by a sensing module). After the sensing module senses that the user enters a sensing range in front of the sanitation apparatus, one or more segments of them multimedia data are broadcasted (Step S40). The time point of first sensing the user is a start point of calculating a sensed in-use duration T, a sensed determination duration T1 or a broadcasting duration T2. The sensing module still senses continuously whether the user leaves (Step S50). If the sensing module senses that the user leaves, a flush control signal is output (Step S60); the time point of first sensing the user has left is defined as a terminal point of the sensed in-use duration T. Afterwards, stop broadcasting the multimedia data (Step S70). In different embodiments, the broadcasting module may synchronously stop the broadcasting of the multimedia data, as shown in FIG. 2A, or as shown in FIG. 2B, the multimedia data is stopped broadcasting after being continuously broadcasted for a broadcasting prolonging duration T3. The condition has many variations during actual use; no matter whether the user stays within the sensing range (the sensed in-use duration T), before the user enters the sensing range stays within the sensing range or after the user leaves the sensing range, it is possible that the multimedia data is broadcasted.

Although this embodiment introduces the flow chart and several steps as shown in FIG. 3 as an example, the disclosure is not limited thereto, and the steps are not limited to the previously described sequence or combination. In another embodiment, the multimedia broadcasting management method includes: connecting the flush control device to the transmission network; receiving the multimedia data through the transmission network; sensing that the user stays within the sensing range while a sensor is in use; and outputting a flush control signal within the time that the sensor is in use, and broadcasting the multimedia data within the time that the sensor is in use.

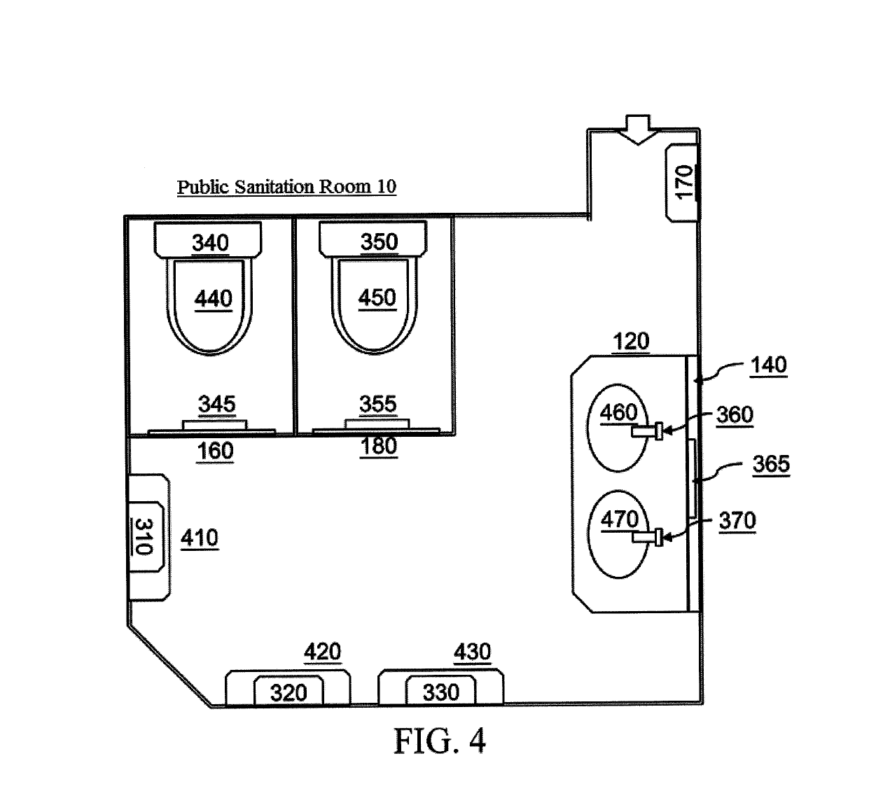

FIG. 4 is a configuration diagram of a public sanitary space of a multimedia data broadcasting system according to an embodiment of the disclosure. In FIG. 4, an entrance sensing module 170 is installed at an entrance of a public sanitary space 10, and transmits a sensing signal of sensing the entering of a user at the entrance to a processing module through a transmission network. The entrance sensing module 170 may be realized by an infrared sensor, an ultrasound sensor, an optical sensor, a thermal sensor, or an image sensor; the entrance sensing module 170 detects/senses whether a user enters or leaves a sensing range of the entrance sensing module, and generates a sensing signal accordingly. Thus, the entrance sensing data sensed by the entrance sensing module 170 may be used as another reference data of the amount of the viewers.

In addition, in the foregoing embodiments, the sensitive urinal funnel of the flush control device is only as an example of the installed sanitation apparatus. A sensitive tap on a wash platform in the public sanitary space or a sensitive closestool also has the same feature as the urinal funnel that the user needs to use them in a fixed position and may be configured with the flush control device. Therefore, the technology provided by the embodiments of the disclosure may be applied thereto as well. The embodiment of the sensitive tap is a sensitive-tap flush control device 360/370 as shown in FIG. 4, and the tap flush control devices 360 and 370 may use the same broadcasting module 365 installed vertically on a front mirror 140 in front of the wash platform 120 at a corresponding position on the front mirror 140 between the tap flush control devices 360 and 370 (no matter the front mirror is installed or not, the broadcasting module 365 may be installed at a corresponding position on the vertical wall between the tap flush control devices 360 and 370). The sanitation apparatus corresponding to the broadcasting module 365 is a washing basin. In another embodiment, each flush control device on the wash platform may also respectively correspond to a broadcasting device installed at a position corresponding to a perpendicular surface on for example the front mirror or wall surface between the flush control devices. The embodiment of the sensitive closestool includes a sensitive closestool 440/450 as the sanitation apparatus, as shown in FIG. 4; and the broadcasting module 345/355 of the flush control device 340/350 may be installed on a cubicle door 160/180 of the sensitive closestool 440/450 (e.g. hanging a panel display device on the cubicle door). As to different cubicle internal configuration, the broadcasting module may not be installed on the cubicle door. If the broadcasting module is a panel display device, the broadcasting module may also be hung on a proper surface of the cubicle walls; if the broadcasting module is a micro projector, the broadcasting module may be installed at the cubicle wall or the cubicle door, and the multimedia data is projected to the cubicle wall at the opposite side for the viewing convenience when the user is sitting on the sensitive closestool. In addition to the general installation position of the sensing module of the urinal funnel, the sensing module of the cubicle sensitive closestool may also be installed at the ceiling, as long as the sensing range is appropriately adjusted.

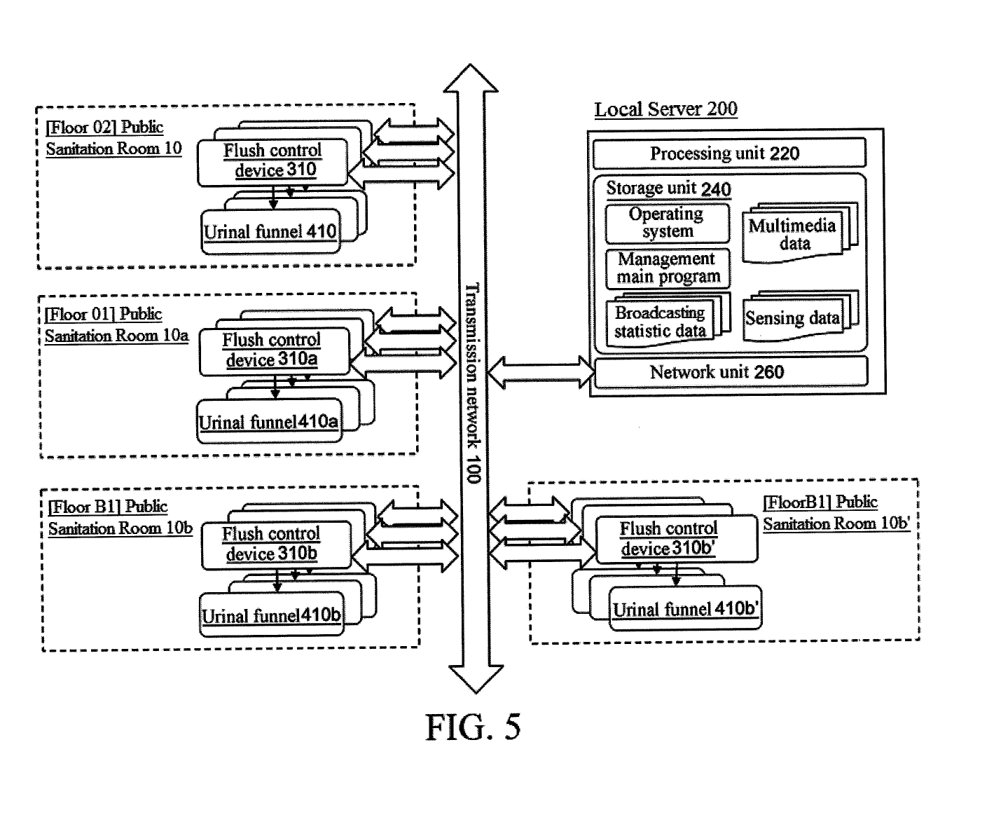

Please refer to FIG. 5, which is a system block diagram of a multimedia broadcasting management system in another public sanitary space according to another embodiment of the disclosure. In this embodiment, a multimedia broadcasting management system includes multiple public sanitary spaces and urinal funnels installed at different floors of one or more building, and remote controllable through a local server 200. If more than one public sanitary spaces and urinal funnels are configured on the same floor, all may be connected through a transmission network 100. In FIG. 5, the local server 200 is connected to different flush control devices 310, 310a, 310b and 310b′ in different public sanitary spaces 10, 10a, 10b and 10b′ on different floors B1, 01 and 02 through the transmission network 100; each flush control device 310/310a/310b/310b′ is correspondingly configured on the urinal funnel (sanitation apparatus) 410/410a/410b/410b′ in the public sanitary space 10/10a/10b/10b.

The local server 200 mainly includes a processing unit 220, a storage unit 240, and a network unit 260, which are connected to one another though a data bus (not shown). The processing unit 20 is used for computing tasks; and the network unit 260 is connected to the transmission network 100. The storage unit 240 stores the multimedia data, the broadcasting data, the broadcasting statistic data and the sensing data of the flush control device 310/310a/310b/310b′. The storage unit 240 is installed with an operating system and multiple executing procedures; one or more of the executing procedures transmits the multimedia data through the transmission network 100, and collects the sensing data transmitted by the flush control device 310/310a/310b/310b′ through the transmission network 100. These sensing data are sent to the processing unit 220 to further process or generate as the broadcasting statistic data. The broadcasting statistic data is selected from the group consisting of multiple history broadcasting durations, multiple history amounts of broadcasting viewers, the amount of broadcasting viewers in at least a certain duration, at least a cumulative broadcasting duration, at least an average broadcasting duration, multiple history in-use durations of the sanitation apparatus, an average in-use duration and a cumulative in-use duration, or any combination thereof. As to a system service provider in a geographic area, a central server may be established, so as to receive the sensing data from multiple buildings/public sanitary spaces/flush control devices through the Internet and multiple local servers at different locations. The central server may be installed with the procedures similar to the local server, and perform remote controls through the multimedia broadcasting management method according to the embodiments of the disclosure.

While the disclosure has been described by the way of example and in terms of the embodiments, it is to be understood that the invention need not be limited to the disclosed embodiments. On the contrary, it is intended to cover various modifications and similar arrangements included within the spirit and scope of the appended claims, the scope of which should be accorded the broadest interpretation so as to encompass all such modifications and similar structures.

What is claimed is:

1. A multimedia broadcasting management system, comprising at least a flush control device installed in at least a public sanitary space, the flush control device comprising:
a network module, connected to a transmission network;
a sensing module, detecting a user in a sensing range and generating a sensing signal accordingly;
a broadcasting module, comprising a broadcast unit; and
a processing module electrically connected with the network module, the sensing module and the broadcasting module, receiving the sensing signal from the sensing module and a plurality of multimedia data transmitted through the transmission network;
wherein when sensing the user stays at the sensing range for a sensed in-use duration, the processing module outputs a flush control signal in the sensed in-use duration, and the broadcasting module broadcasts the multimedia data in the sensed in-use duration.

2. The multimedia broadcasting management system according to claim 1, wherein the flush control device is installed on a sanitation apparatus selected from the group consisting of a sensitive urinal funnel, a washing basin with a sensitive tap, and a sensitive closestool or any combination thereof.

3. The multimedia broadcasting management system according to claim 1, wherein at least two sensing-tap flush control devices are installed on a wash platform in the public sanitary space, and the broadcasting module being installed at a position on a perpendicular surface in front of the wash platform between the two sensing-tap flush control devices.

4. The multimedia broadcasting management system according to claim 1, wherein at least a sensing-tap flush control device is installed on a wash platform in the public sanitary space, and the broadcasting module being installed at a position on a perpendicular surface in front of the wash platform and solely corresponding to the sensing-tap flush control device.

5. The multimedia broadcasting management system according to claim 1, wherein the sanitation apparatus is a closestool, and the broadcasting module of the flush control device is installed at a cubicle wall or a cubicle door.

6. The multimedia broadcasting management system according to claim 1, wherein the multimedia data is broadcasted for a broadcasting duration, and the broadcasting duration is greater than the sensed in-use duration.

7. The multimedia broadcasting management system according to claim 1, wherein when sensing the user has left, the multimedia data is further broadcasted continuously for a broadcasting prolonging duration.

8. The multimedia broadcasting management system according to claim 1, wherein the broadcasting module stops broadcasting the multimedia data by means selected from the group consisting of turning off a main power source, turning off a backlight component power source, broadcasting a screen protection program, entering a standby mode and entering a sleep mode or any combination thereof.

9. The multimedia broadcasting management system according to claim 1 further comprising:
an entrance sensing module installed at an entrance of the public sanitary space, outputting the sensing signal of the user at the entrance of the public sanitary space through the transmission network.

10. A multimedia broadcasting management system, broadcasting a plurality of multimedia data and outputting a flush control signal, the system comprising:
a transmission network; and
a plurality of flush control devices installed in at least a public sanitary space, comprising:
a network module, connected to the transmission network;
a sensing module, detecting a user in a sensing range and generating a sensing signal accordingly;
a broadcasting module, comprising a broadcast unit; and
a processing module connected electrically to the network module, the sensing module and the broadcasting module, receiving the sensing signal from the sensing module and outputting sensing data through the network module; and
at least a local server connected to the flush control device through the transmission network, so as to receive the sensing data and transmit the multimedia data to the flush control device through the transmission network;
wherein when sensing the user enters the sensing range, the processing module outputs a flush control signal, and controls the broadcasting module to start broadcasting the multimedia data.

11. The multimedia broadcasting management system according to claim 10, wherein the flush control signal is output after sensing the user has entered the sensing range for a sensed determination duration, and the multimedia data is broadcasted as soon as sensing the user enters the sensing range.

12. The multimedia broadcasting management system according to claim 10, wherein when sensing the user has left, the multimedia data is further broadcasted continuously for a broadcasting prolonging duration.

13. The multimedia broadcasting management system according to claim 10 further comprising:
a central server connected to the local server through Internet, and the local server transmitting the sensing data to the central server.

14. A multimedia broadcasting management method, applied to a flush control device corresponding to at least a sanitation apparatus in at least a public sanitary space, the method comprising:
connecting the flush control device to a transmission network;
receiving at least a segment of multimedia data through the transmission network;
sensing if a user stays within a sensing range for a sensed in-use duration; and
outputting a flush control signal within the t sensed in-use duration, and broadcasting the multimedia data within the sensed in-use duration.

15. The multimedia broadcasting management method according to claim 14, wherein when sensing the user has left, the multimedia data is further broadcasted continuously for a broadcasting prolonging duration.

16. The multimedia broadcasting management method according to claim 14 further comprising:
transmitting sensing data through the transmission network;
wherein the sensing data is selected from the group consisting of a fore-flush duration, a post-flush duration, a consumed amount of water, the amount of users and the sensed in-use duration represented by a sensing signal, an identification code and a positional code of the sanitation apparatus, an identification code and a positional code of the belonged public sanitary space, and an identification code and a positional code of a belonged building or any combination thereof.

17. The multimedia broadcasting management method according to claim 16, further comprising:
calculating broadcasting statistic data according to the sensing data of the flush control device;
wherein the broadcasting statistic data is selected from the group consisting of a plurality of history broadcasting durations, a plurality of history amounts of broadcasting viewers, the amount of broadcasting viewers in at least a certain duration, at least a cumulative broadcasting duration, at least an average broadcasting duration, a plurality of history in-use durations of the sanitation apparatus, an average in-use duration and a cumulative in-use duration or any combination thereof.

18. The multimedia broadcasting management method according to claim 14, wherein the multimedia data is broadcasted for a broadcasting duration, and the broadcasting duration is greater than the sensed in-use duration.

19. The multimedia broadcasting management method according to claim 14, wherein the multimedia data is stopped broadcasting by means selected from the group consisting of turning off a main power source, turning off a backlight component power source, broadcasting a screen protection program, entering a standby mode and entering a sleep mode or any combination thereof.

20. The multimedia broadcasting management method according to claim 14, wherein the flush control signal is output after sensing a user has entered the sensing range for a sensed in-use duration, and the multimedia data is broadcasted as soon as sensing the user enters the sensing range.
